(19) United States
(12) Patent Application Publication
(10) Pub. No.: US 2020/0097487 A1
(43) Pub. Date: Mar. 26, 2020

(54) NOVEL OLAP PRE-CALCULATION MODEL AND MODELING METHOD

(71) Applicant: SHANGHAI KYLIGENCE INFORMATION TECHNOLOGY Co.,Ltd., Pudong District, Shanghai (CN)

(72) Inventors: Cheng WANG, Pudong District, Shanghai (CN); Yang LI, Pudong District, Shanghai (CN); Qing HAN, Pudong District, Shanghai (CN)

(21) Appl. No.: 15/769,427

(22) PCT Filed: Jan. 19, 2018
(86) PCT No.: PCT/CN2018/073321

§ 371 Date: Nov. 18, 2019

(30) Foreign Application Priority Data
Dec. 29, 2017 (CN) 201711487497.4

(51) Int. Cl. G06F 16/28; G06F 16/2455; G06F 16/25; G06F 16/23

(52) U.S. Cl. CPC G06F 16/282; G06F 16/2358; G06F 16/258; G06F 16/2455

(57) ABSTRACT

The OLAP pre-calculation model and a modeling method includes a query engine, a SQL converter, and a dimension combination storage device. The modeling method includes: acquiring a SQL query statement; parsing the SQL query statement into a corresponding dimension combination; querying for the present dimension combination among built dimension combinations to ascertain whether the present dimension combination exists among the built dimension combinations; logging information on the corresponding dimension combination in the dimension combination storage device, if the present dimension combination doesn't exist; and forming a set of discrete dimension combinations, and building each dimension combination hierarchically according to the correlation among the discrete dimension combinations. Dimension combinations can be updated continually in the dimension combination storage device, so that the model supports staged building in a time increment manner and building in a dimension and measurement increment manner.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention belongs to the OLAP big data information field, and particularly relates to a novel OLAP pre-calculation model and a modeling method.

### 2. Description of Related Art Including Information Disclosed Under 37 CFR 1.97 and 37 CFR 1.98

In conventional OLAP pre-calculation, to adapt to possible query scenarios, more Cuboids are contained as far as possible during Cube building. Usually, for a Cube with N dimensions, the quantity of Cuboids may be up to Nth power of 2. Therefore, in a case that the scale of data is large and the quantity of dimensions is large, a great deal of time will be consumed and the pre-calculation results will occupy storage space heavily in the modeling process. Through some measures may be taken to remove some Cuboids, a certain number of Cuboids that are never used in the query process always exist, resulting in severe waste. On the other hand, the granularity of building with the existing scheme in the prior art is Cube. Once a Cube is built, the metadata in it can't be modified any more. To make any modification to the original Cube, even to add a new dimension or measurement, a new Cube has to be built completely, and a rebuilding process is required. Consequently, the previous calculations results can't be utilized, and the flexibility is poor.

### BRIEF SUMMARY OF THE INVENTION

The technical problem to be solved in the present invention is: the granularity of building in the prior art is Cube. Once a Cube is defined and built, the metadata in it can't be modified any more. Consequently, the previous calculation results can't be utilized, and the flexibility is poor.

To solve the technical problem described above, the present invention provides a novel OLAP pre-calculation model.

The novel OLAP pre-calculation model comprises: a query engine, a SQL converter, and a dimension combination storage device; wherein,

the SQL converter is configured to convert an inputted SQL query statement into a corresponding dimension combination;

the query engine is configured to query for the dimension combination among a plurality of built dimension combinations in the dimension combination storage device according to the corresponding dimension combination to ascertain whether a dimension combination matching the SQL query statement exists;

the query engine is further configured to log information on the corresponding dimension combination and send information on the corresponding dimension combination to the dimension combination storage device, if no matching dimension combination exists; and

the dimension combination storage device is configured to build the matching dimension combination according to the correlation among the discrete dimension combinations and the information on the corresponding dimension combination, and form a new topological hierarchy structure with the matching dimension combination and the built dimension combinations hierarchically.

The present invention has the following beneficial effects: With the model described above, dimension combinations can be updated continually in the dimension combination storage device, so that the model not only supports staged building in a time increment manner, but also supports building in a dimension and measurement increment manner; in addition, the model greatly improves query efficiency, reduce required storage space, and ensures query response rate.

Furthermore, the dimension combination storage device is further configured to query for a result directly from source data, if no dimension combination matching the SQL query statement exists.

Furthermore, the dimension combination storage device comprises: a plurality of built dimension combinations, wherein, some dimension combinations are dimension combinations that are built on the basis of a MapRecuce computing framework and have a hierarchical topology structure, while the other dimension combinations are dimension combinations that are discrete from each other and don't have a hierarchical topology structure.

Furthermore, in the dimension combinations that have a hierarchical topology structure, pre-calculation results of dimension combinations at a lower layer are obtained through aggregation calculation of pre-calculation results of dimension combinations at a higher layer.

Furthermore, the dimension combination storage device is specifically configured to build a new dimension combination formed as a result of dimension or measurement increment according to the correlation among the discrete dimension combinations and the information on the corresponding dimension combination, and merge the new dimension combination and a dimension combination among the built dimension combinations into the matching dimension combination.

The present invention further relates to a novel modeling method for OLAP pre-calculation model, which comprises:

S1. reading a SQL query statement, by a SQL converter;

S2. converting an inputted SQL query statement into a corresponding dimension combination, by the SQL converter;

S3. querying for the dimension combination among built dimension combinations in the dimension combination storage device according to the corresponding dimension combination to ascertain whether a dimension combination matching the SQL query statement exists, by the query engine;

S4. logging information on the corresponding dimension combination and sending information on the corresponding dimension combination to the dimension combination storage device, by the query engine, if no matching dimension combination exists; and

S5. building the matching dimension combination according to the correlation among the discrete dimension combinations and the information on the corresponding dimension combination, and forming a new topological hierarchy structure with the matching dimension combination and the built dimension combinations hierarchically, by the dimension combination storage device.

The present invention has the following beneficial effects: With the modeling method described above, the dimension combinations can be updated continually, and staged building in a time increment manner and building in a dimension or measurement increment manner are supported; in addition, the building efficiency can be improved greatly, the required storage space can be reduced, and the query response rate can be ensured.

Furthermore, the step S4 further comprises: querying for a result directly from source data, if no dimension combination matching the SQL query statement exists.

Furthermore, the dimension combination storage device comprises: a plurality of built dimension combinations, wherein, some dimension combinations are dimension combinations that are built on the basis of a MapRecuce computing framework and have a hierarchical topology structure, while the other dimension combinations are dimension combinations that are discrete from each other and don't have a hierarchical topology structure.

Furthermore, in the dimension combinations that have a hierarchical topology structure, pre-calculation results of dimension combinations at a lower layer are obtained through aggregation calculation of pre-calculation results of dimension combinations at a higher layer.

Furthermore, the operation of building the matching dimension combination in the step S5 comprises:

building a new dimension combination formed as a result of dimension or measurement increment, and merging the new dimension combination and a dimension combination among the plurality of built dimension combinations into the matching dimension combination.

### BRIEF DESCRIPTION OF THE SEVERAL VIEWS OF THE DRAWINGS

FIG. 1 is a schematic view of a structural diagram of the novel OLAP pre-calculation model provided in the present invention.

FIG. 2 is a flow diagram of the novel modeling method for OLAP pre-calculation model provided in the present invention.

FIG. 3 is a schematic view of a structural diagram of dimension combinations that have a hierarchical topology structure.

FIG. 4 is a schematic view of a structural diagram of aggregate operation among different layers in the hierarchy in the present invention.

FIG. 5 is a schematic view of a structural diagram of Spanning Tree in the present invention.

FIG. 6 is a schematic view of a structural diagram of dimension or measurement increment in the present invention.

### DETAILED DESCRIPTION OF THE INVENTION

Hereunder the principle and features of the present invention will be detailed with reference to the accompanying drawings. However, it should be noted that the embodiments are provided only to interpret the present invention but don't constitute any limitation to the scope of the present invention.

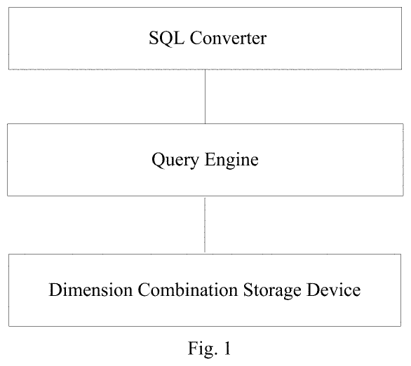

As shown in FIG. 1, in embodiment 1 of the present invention, a novel OLAP pre-calculation model is provided.

The novel OLAP pre-calculation model comprises: a query engine, a SQL converter, and a dimension combination storage device; wherein,

the SQL converter is configured to convert an inputted SQL query statement into a corresponding dimension combination;

the query engine is configured to query for the dimension combination among a plurality of built dimension combinations in the dimension combination storage device according to the corresponding dimension combination to ascertain whether a dimension combination matching the SQL query statement exists;

the query engine is further configured to log information on the corresponding dimension combination and send information on the corresponding dimension combination to the dimension combination storage device, if no matching dimension combination exists; and

the dimension combination storage device is configured to build the matching dimension combination according to the correlation among the discrete dimension combinations and the information on the corresponding dimension combination, and form a new topological hierarchy structure with the matching dimension combination and the built dimension combinations hierarchically.

It can be understood: in the embodiment 1, the model is implemented by adding a SQL converter on the basis of the conventional model, and the SQL converter is mainly used to convert a SQL query statement submitted by the user into a corresponding Cuboid (dimension combination), a Cube concept is involved in the conventional model, but is not involved in the model in the embodiment 1; instead, a set of Cuboids obtained through conversion with the SQL converter are used; in that way, the model in the embodiment 1 is improved from original Cube granularity to finer and more flexible Cuboid granularity, and thereby time incremental building and dimension incremental building are supported. Finally, the discrete Cuboids are organized by means of a Spanning Tree to find out the most reasonable topology structure for building, and thereby the building efficiency is ensured.

In addition, in the query process in the conventional OLAP pre-calculation model, the most appropriate Cuboid has to be found out for the query according to the SQL query statement. However, the specific query scenario is unknown when a Cube is built in the conventional OLAP pre-calculation model. Therefore, an optimal Cuboid may not always be hit for each SQL query statement, and other Cuboids have to be used for the query. Consequently, the query effect may not be ideal. In contrast, with the model in the embodiment 1, after the user submits a SQL query statement, first, the system will find out a usable Cuboid for the query in a set of Cuboids stored previously. If no appropriate Cuboid is found, the query will be handed over to another query engine, and the Cuboid that is required by the SQL query statement but doesn't exist will be logged and put into a set of Cuboids to be built (i.e., a dimension combination storage device) at the same time.

With the model in the embodiment 1, dimension combinations can be updated continually in the dimension combination storage device, so that the model not only supports staged building in a time increment manner, but also supports building in a dimension or measurement increment manner; in addition, the model greatly improves query efficiency, reduce required storage space, and ensures query response rate.

Optionally, in an embodiment 2, the dimension combination storage device is further configured to query for a result directly from source data, if no dimension combination matching the SQL query statement exists.

It can be understood: the embodiment 2 provides a scheme for implementing a different embodiment on the basis of the embodiment 1. In the embodiment 2, a result is obtained directly from the source data if no dimension combination matching the SQL query statement exists in the dimension combination storage device.

Optionally, in an embodiment 3, the dimension combination storage device comprises: a plurality of built dimension combinations, wherein, some dimension combinations are dimension combinations that are built on the basis of a MapRecuce computing framework and have a hierarchical topology structure, while the other dimension combinations are dimension combinations that are discrete from each other and don't have a hierarchical topology structure.

It can be understood: the embodiment 3 provides a scheme for implementing a different embodiment on the basis of the above embodiment. In the existing OLAP pre-calculation building, Cuboids can be built hierarchically only after required models and Cube are defined. Therefore, the prior art supports building in a time increment manner, but doesn't support building in a dimension or measurement increment manner, because a Cube can't be modified once it is defined in the prior art. All Cuboids are confined by measurements and dimensions defined by Cube. In contrast, the embodiment 3 supports building at Cuboid granularity. It is only confined by the definition of the model. Therefore, dimensions and measurements can be added or deleted at any time within the scope of the model.

Optionally, in an embodiment 4, in the dimension combinations that have a hierarchical topology structure, pre-calculation results of dimension combinations at a lower layer are obtained through aggregation calculation of pre-calculation results of dimension combinations at a higher layer.

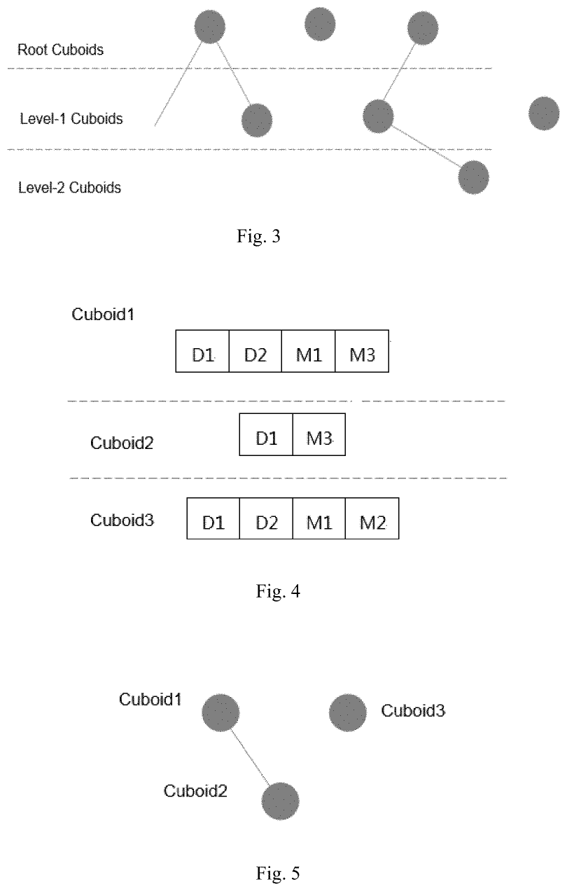

It can be understood: the embodiment 4 provides a scheme for implementing a different embodiment on the basis of the above embodiment. In the embodiment 4, since the model is not confined by the definition of a specific Cube, each Cuboid is independent, and the dimensions and measurements may be different between Cuboids. Therefore, a hierarchical relation may not always exist between Cuboids. However, since the dimensions and measurements of each Cuboid is not beyond the scope defined by the model, it is possible that a correlation exists between different Cuboids. Therefore, Cuboids that are correlated with each other are grouped together as far as possible, to avoid repeated aggregation calculation in the building process. As shown in FIG. 3, the worst case is that there is no correlation between the Cuboids. In that case, only a root node exists in the structural diagram, and the source data will be used as the input in the building process. If a hierarchical structure exists, the Cuboids at a lower layer may be pre-calculated and built hierarchically with the Cuboid results at a higher layer.

To describe the tree building process better, suppose a data model contains four dimensions D1, D2, D3 and D4 and contains four measurements M1, M2, M3 and M4. After the user submits a query, the SQL converter will generates 3 Cuboids (see FIG. 4 for the structure). There is a hierarchical relation between Cuboid 1 and Cuboid 2, and the Cuboid 3 is separate. Finally, a Spanning Tree (pattern relation tree) is built, the structure of which is shown in FIG. 5. In the building process, aggregation calculation is carried out for Cuboid 1 and Cuboid 3 directly using the source data as the input, while the calculation is carried out for Cuboid 2 utilizing the aggregation result of Cuboid 1.

Optionally, in an embodiment 5, the dimension combination storage device is specifically configured to build a new dimension combination formed as a result of dimension or measurement increment according to the correlation among the discrete dimension combinations and the information on the corresponding dimension combination, and merge the new dimension combination and a dimension combination among the built dimension combinations into the matching dimension combination.

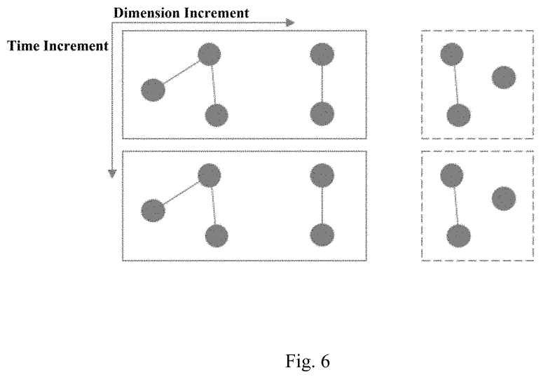

It can be understood: the embodiment 5 provides a scheme for implementing a different embodiment on the basis of the above embodiment. As shown in FIG. 6, the solid line rectangle represents the data field of an abstract Cube the solid circles represent Cuboid, and certain correlation may exists between different Cuboids. The dotted line rectangle represents a new Cuboid generated as a result of dimension or measure increment, which will be merged into the corresponding existing data field after the building process is completed.

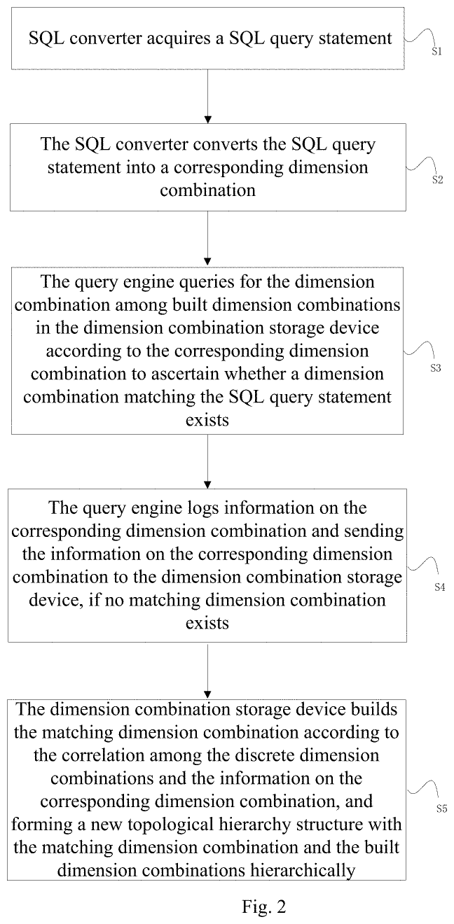

As shown in FIG. 2, an embodiment 6 of the present invention relates to a novel modeling method for OLAP pre-calculation model, which comprises:

S1. reading a SQL query statement, by a SQL converter;

S2. converting an inputted SQL query statement into a corresponding dimension combination, by the SQL converter;

S3. querying for the dimension combination among built dimension combinations in the dimension combination storage device according to the corresponding dimension combination to ascertain whether a dimension combination matching the SQL query statement exists, by the query engine;

S4. logging information on the corresponding dimension combination and sending information on the corresponding dimension combination to the dimension combination storage device, by the query engine, if no matching dimension combination exists;

S5. building the matching dimension combination according to the correlation among the discrete dimension combinations and the information on the corresponding dimension combination, and forming a new topological hierarchy structure with the matching dimension combination and the built dimension combinations hierarchically, by the dimension combination storage device.

It can be understood: in the embodiment 6, the model is implemented by adding a SQL converter on the basis of the conventional model, and the SQL converter is mainly used to convert a SQL query statement submitted by the user into a corresponding Cuboid (dimension combination). A Cube concept is involved in the conventional model, but is not involved in the model in the embodiment 6; instead, a set of Cuboids obtained through conversion with the SQL converter are used, or dimension combinations pre-stored in the dimension combination storage device may be used. In that way, the model in the embodiment 6 is improved from original Cube granularity to finer and more flexible Cuboid granularity, and thereby time incremental building and dimension incremental building are supported. Finally, the discrete Cuboids are organized by means of a Spanning Tree to find out the most reasonable topology structure for building, and thereby the building efficiency is ensured.

In addition, in the query process in the conventional OLAP pre-calculation model, the most appropriate Cuboiod has to be found out for the query according to the SQL query statement. However, the specific query scenario is unknown when a Cube is built in the conventional OLAP pre-calculation model. Therefore, an optimal Cuboid may not always be hit for each SQL query statement, and other Cuboids have to be used for the query. Consequently, the query effect may not be ideal. In contrast, in the embodiment 6, after the user submits a SQL query statement, first, the system will find out a usable Cuboid for the query in a set of Cuboids stored previously. If no appropriate Cuboid is found, the query will be handed over to another query engine, and the Cuboid that is required by the SQL query statement but doesn't exist will be logged and put into a set of Cuboids to be built (i.e., a dimension combination storage device) at the same time. With the modeling method in the embodiment 6, the dimension combinations can be updated continually, and staged building in a time increment manner and building in a dimension or measurement increment manner are supported; in addition, the building efficiency can be improved greatly, the required storage space can be reduced, and the query response rate can be ensured.

Optionally, in an embodiment 7, the step S4 further comprises: querying for a result directly from source data, if no dimension combination matching the SQL query statement exists.

It can be understood: the embodiment 7 provides a scheme for implementing a different embodiment on the basis of the embodiment 6. In the embodiment 7, a result is obtained directly from the source data if no dimension combination matching the SQL query statement exists in the dimension combination storage device.

Optionally, in an embodiment 8, the dimension combination storage device comprises: a plurality of built dimension combinations, wherein, some dimension combinations are dimension combinations that are built on the basis of a MapRecuce computing framework and have a hierarchical topology structure, while the other dimension combinations are dimension combinations that are discrete from each other and don't have a hierarchical topology structure.

It can be understood: the embodiment 8 provides a scheme for implementing a different embodiment on the basis of the above embodiment. In the existing OLAP pre-calculation building, Cuboids can be built hierarchically only after required models and Cube are defined. Therefore, the prior art supports building in a time increment manner, but doesn't support building in a dimension or measurement increment manner, because a Cube can't be modified once it is defined in the prior art. All Cuboids are confined by measurements and dimensions defined by Cube. In contrast, the embodiment 8 supports building at Cuboid granularity. It is only confined by the definition of the model. Therefore, dimensions and measurements can be added or deleted at any time within the scope of the model.

Optionally, in an embodiment 9, in the dimension combinations that have a hierarchical topology structure, pre-calculation results of dimension combinations at a lower layer are obtained through aggregation calculation of pre-calculation results of dimension combinations at a higher layer.

It can be understood: the embodiment 9 provides a scheme for implementing a different embodiment on the basis of the above embodiment. In the embodiment 9, since the model is not confined by the definition of a specific Cube, each Cuboid is independent, and the dimensions and measurements may be different between Cuboids. Therefore, a hierarchical relation may not always exist between Cuboids. However, since the dimensions and measurements of each Cuboid is not beyond the scope defined by the model, it is possible that a correlation exists between different Cuboids. Therefore, Cuboids that are correlated with each other are grouped together as far as possible, to avoid repeated aggregation calculation in the building process. As shown in FIG. 3, the worst case is that there is no correlation between the Cuboids. In that case, only a root node exists in the structural diagram, and the source data will be used as the input in the building process. If a hierarchical structure exists, the Cuboids at a lower layer may be pre-calculated and built hierarchically with the Cuboid results at a higher layer.

To describe the tree building process better, suppose a data model contains four dimensions D1, D2, D3 and D4 and contains four measurements M1, M2, M3 and M4. After the user submits a query, the SQL converter will generates 3 Cuboids (see FIG. 4 for the structure). There is a hierarchical relation between Cuboid 1 and Cuboid 2, and the Cuboid 3 is separate. Finally, a Spanning Tree is built, the structure of which is shown in FIG. 5. In the building process, aggregation calculation is carried out for Cuboid 1 and Cuboid 3 directly using the source data as the input, while the calculation is carried out for Cuboid 2 utilizing the aggregation result of Cuboid 1.

Optionally, in an embodiment 10, the operation of building the matching dimension combination in the step S5 comprises:

building a new dimension combination formed as a result of dimension or measurement increment, and merging the new dimension combination and a dimension combination among the plurality of built dimension combinations into the matching dimension combination.

It can be understood: the embodiment 10 provides a scheme for implementing a different embodiment on the basis of the above embodiment. As shown in FIG. 6, the solid line rectangle represents the data field of an abstract Cube the solid circles represent Cuboid, and certain correlation may exists between different Cuboids. The dotted line rectangle represents a new Cuboid generated as a result of dimension or measure increment, which will be merged into the corresponding existing data field after the building process is completed.

In this document, the exemplary expression of the above terms may not necessarily refer to the same embodiment or example. Moreover, the specific features, structures, materials, or characteristics described can be combined appropriately in any one or more embodiments or examples. Furthermore, those skilled in the art may combine or assemble different embodiments or examples and features in different embodiments or examples described herein, provided that there is no contradiction between them.

While the present invention is described above in some preferred embodiments, the present invention is not limited to those preferred embodiments. Any modification, equivalent replacement, and improvement made without departing from the spirit and principle of the present invention shall be deemed as falling into the scope of protection of the present invention.

1. A OLAP pre-calculation model, comprising:
a query engine;
a SQL converter; and
a dimension combination storage device,
wherein the SQL converter is configured to convert an inputted SQL query statement into a corresponding dimension combination,
wherein the query engine is configured to query for the dimension combination among a plurality of built dimension combinations in the dimension combination storage device according to the corresponding dimension combination to ascertain whether a dimension combination matching the SQL query statement exists,
wherein the query engine is further configured to log information on the corresponding dimension combination and send information on the corresponding dimension combination to the dimension combination storage device, if no matching dimension combination exists, and
wherein the dimension combination storage device is configured to build the matching dimension combination according to the correlation among the discrete dimension combinations and the information on the corresponding dimension combination, and form a new topological hierarchy structure with the matching dimension combination and the built dimension combinations hierarchically.

2. The OLAP pre-calculation model according to claim 1,
Wherein the dimension combination storage device is further configured to query for a result directly from source data, if no dimension combination matching the SQL query statement exists.

3. The OLAP pre-calculation model according to claim 1,
wherein the dimension combination storage device comprises: a plurality of built dimension combinations,
wherein some dimension combinations are dimension combinations that are built on the basis of a MapRecuce computing framework and have a hierarchical topology structure, while the other dimension combinations are dimension combinations that are discrete from each other and do not have a hierarchical topology structure.

4. The OLAP pre-calculation model according to claim 3, wherein, in the dimension combinations that have a hierarchical topology structure, pre-calculation results of dimension combinations at a lower layer are obtained through aggregation calculation of pre-calculation results of dimension combinations at a higher layer.

5. The novel OLAP pre-calculation model according to claim 3, wherein the dimension combination storage device is specifically configured to build a new dimension combination formed as a result of dimension or measurement increment according to the correlation among the discrete dimension combinations and the information on the corresponding dimension combination, and merge the new dimension combination and a dimension combination among the built dimension combinations into the matching dimension combination.

6. A modeling method for OLAP pre-calculation model, comprising the steps of:
S1. reading a SQL query statement, by a SQL converter;
S2. converting an inputted SQL query statement into a corresponding dimension combination, by the SQL converter;
S3. querying for the dimension combination among built dimension combinations in the dimension combination storage device according to the corresponding dimension combination to ascertain whether a dimension combination matching the SQL query statement exists, by the query engine;
S4. logging information on the corresponding dimension combination and sending information on the corresponding dimension combination to the dimension combination storage device, by the query engine, if no matching dimension combination exists; and
S5. building the matching dimension combination according to the correlation among the discrete dimension combinations and the information on the corresponding dimension combination, and forming a new topological hierarchy structure with the matching dimension combination and the built dimension combinations hierarchically, by the dimension combination storage device.

7. The modeling method according to claim 6,
wherein the step S4 further comprises the step of: querying for a result directly from source data, if no dimension combination matching the SQL query statement exists.

8. The modeling method according to claim 6,
wherein the dimension combination storage device comprises: a plurality of built dimension combinations,
wherein some dimension combinations are dimension combinations that are built on the basis of a MapRecuce computing framework and have a hierarchical topology structure, while the other dimension combinations are dimension combinations that are discrete from each other and don't have a hierarchical topology structure.

9. The modeling method according to claim 8,
wherein, in the dimension combinations that have a hierarchical topology structure, pre-calculation results of dimension combinations at a lower layer are obtained through aggregation calculation of pre-calculation results of dimension combinations at a higher layer.

10. The modeling method according to claim 8, wherein the operation of building the matching dimension combination in the step S5 comprises steps of:
building a new dimension combination formed as a result of dimension or measurement increment; and
merging the new dimension combination and a dimension combination among the plurality of built dimension combinations into the matching dimension combination.
